(19) United States
(12) Patent Application Publication
(10) Pub. No.: US 2025/0055341 A1
(43) Pub. Date: Feb. 13, 2025

(54) Electrically Insulated Conductors

(71) Applicant: Laird Technologies, Inc., Chesterfield, MO (US)

(72) Inventors: Martino BAILONI, Altopiano della Vigolana (IT); Eric Olivier KANICKI, Dublin, OH (US); Jan KASPAR, Charstava (CZ); Olga SHTYKA, Meyrin (CH)

(21) Appl. No.: 18/930,199

(22) Filed: Oct. 29, 2024

Related U.S. Application Data
(63) Continuation of application No. PCT/US2023/020666, filed on May 2, 2023.
(60) Provisional application No. 63/340,147, filed on May 10, 2022.

(51) Int. Cl. H02K 3/30; H01B 7/02; H01B 7/28; H02K 15/04

(52) U.S. Cl. CPC H02K 3/30; H01B 7/0208; H01B 7/2813; H02K 15/0414

(57) ABSTRACT

Exemplary embodiments are disclosed of electrically insulated conductors. In exemplary embodiments, an electrically insulated conductor comprises an electrically conductive core and one or more electrically nonconductive layers. The one or more electrically nonconductive layers include adhered end portions parallel to and/or longitudinally extending at least partially along the length of the electrically conductive core. The one or more electrically nonconductive layers are at least partially along the perimeter of the electrically conductive core.

### CROSS-REFERENCE TO RELATED APPLICATIONS

The present application is a continuation of PCT International Application No. PCT/US2023/020666 filed May 2023, which published as WO 2023/219830 on Nov. 16, 2023. PCT International Application No. PCT/US2023/020666 claims priority to and the benefit of U.S. Provisional Patent Application No. 63/340,147 filed May 10, 2022. The entire disclosures of the above applications are incorporated herein by reference.

### FIELD

The present disclosure generally relates to electrically insulated conductors.

### BACKGROUND

This section provides background information related to the present disclosure which is not necessarily prior art.

Electric vehicles are commonly used today, which use is expected to increase considerably over time. The electric motors used in electric vehicles may be driven by pulse width modulated (PWM) inverters.

### DRAWINGS

The drawings described herein are for illustrative purposes only of selected embodiments and not all possible implementations and are not intended to limit the scope of the present disclosure.

FIG. 1 illustrates an electrically insulated conductor according to an exemplary embodiment of the present disclosure.

FIG. 2 illustrates an electrically insulated conductor according to another exemplary embodiment of the present disclosure.

FIG. 3 illustrates an electrically insulated conductor according to a further exemplary embodiment of the present disclosure.

FIG. 4 illustrates an exemplary system that may be used for providing an electrically nonconductive or electrically insulating layer to an electrically conductive core.

Corresponding reference numerals may indicate corresponding (though not necessarily identical) features throughout the several views of the drawings.

### DETAILED DESCRIPTION

Example embodiments will now be described more fully with reference to the accompanying drawings.

The electric vehicle industry is moving towards Silicon Carbide (SIC) and Gallium Nitride (GaN) inverter technology to increase the DC voltage to the stator windings despite the impact of the dv/dt and resulting risetime not being fully appreciated or known. As recognized herein, the increased DC voltage and currents applied to the stator windings will increase electrical stress on the electrical insulation system. If not addressed, the increased electrical stress (phase to phase and turn to turn) may shorten the operational lifetime of the electrical insulation and the electric motor.

Exemplary embodiments of electrically insulated conductors were developed and/or are disclosed herein that may be configured to increase the lifetime due to electrical stress (phase to phase and turn to turn) and reduce the amount of insulation materials for wire wrapping as compared to conventional technology. Although conventional corona resistant insulation solutions may be sufficiently robust to deal with the increased DC voltage and currents applied to stator windings, conventional corona resistant insulation solutions tend to be relatively costly and not economical.

In exemplary embodiments disclosed herein, an electrical conductor is provided with insulation that is specifically targeted at areas of high electrical field on a magnet wire (e.g., copper, aluminum, stainless steel, alloys thereof, other metals, other electrical conductors, etc.) in a winding driven by a converter device (e.g., a stator winding in an electric motor or other power electronic device, etc.). The magnet wire is insulated with corona resistant film without significantly increasing the overall cross-sectional area of the magnet wire.

In exemplary embodiments, the corona resistant film comprises a thin corona resistant film including a single sided fluoropolymer coating that is heat fusible to copper and to itself. Alternatively, other electrically insulative materials may be used that preferably are relatively thin, have good dielectric strength, and are coated using a one-sided adhesive system functionalized for dv/dt resistance and corona resistant. In other exemplary embodiments, the electrically insulative material comprises a functionalized dielectric layer designed for through plane thermal conductivity and/or partial discharge resistance.

In exemplary embodiments, the electrically insulative material has a multilayer structure comprising at least one or more dielectric layers. The at least one or more dielectric layers may include one or more of enamel (or other polymer coating), corona resistant enamel, adhesive promoter, varnish, extruded polymer, a polymer film, and/or a polymer functionalized with inorganic particles. The multilayer structure may comprise one or more semi-conductive layers, e.g., configured to help reduce corona induced breakdown of the insulation, etc.

Exemplary embodiments disclosed herein may provide or include one or more (but not necessarily any or all) of the following advantageous effects or features, such as higher efficiency, lower operating temperature, increased power density, increased motor voltages, dv/dt resistant, withstand SiC/GaN inverters, higher copper fill, longer operating lifetime and reliability, and/or increased partial discharge inception voltage (PDIV). By using a corona resistant film (e.g., a single layer film, a multilayer structure, etc.), less insulation material (e.g., ⅛ times less material, etc.) may be used in exemplary embodiments disclosed herein as compared to traditional insulation methods. Exemplary embodiments may include a high copper fill factor and improve e-motor efficiency. The improved e-motor efficiency translates to more mileage with the same battery pack and/or a smaller battery pack resulting in less cost per battery pack for each electric vehicle. Exemplary embodiments disclosed herein may also fundamentally enable higher efficiency and design freedom to an original equipment manufacturer (OEM). In exemplary embodiments, a corona resistant film is adhered using one or more ways, such as Fluoropolymer (e.g., Perfluoroalkoxy alkanes (PFA), Fluorinated ethylene propylene (FEP), etc.) and/or polyimide with a certain Tg (glass transition temperature) of 220 to 400 degrees Celsius (C) under cured enamel and process curing with a commercially available KAPTON® film applied, etc. Regarding design freedom, exemplary embodiments may allow for reduced slot dimension, higher copper content for the same slot dimension, smaller packaging, insulation for 3D printed coils, and/or dielectric barrier for the distributed electric winding.

Conventionally, the thickness of the insulation may be significantly increased to accommodate for the increased DC voltage and currents applied to stator windings. But the increased insulation thickness reduces the copper fill factor, which, in turn, reduces efficiency. In contrast, exemplary embodiments disclosed herein provide an economical approach to increase the reliability and enable the market trend in e-mobility, such as in aerospace e-mobility applications in which the stress can be significantly higher. For example, exemplary embodiments include an electrically conductive core that is only partially provided (e.g., not on all sides, etc.) with insulation, which can reduce insulation material for such embodiments that do not require fully wrapping the electrically conductive core/wire with insulation.

Exemplary embodiments disclosed herein are not limited to use with only electric motors of electric vehicles. Exemplary embodiments disclosed herein may be used with a wide range of electronic devices, including power electronics devices for aircraft, marine, industrial, automotive, etc., electric motors driven by pulse width modulated inverters, high switching frequency converters providing signals with high levels of dv/dt, traction motors for e-mobility applications, other windings driven by converter devices, etc.

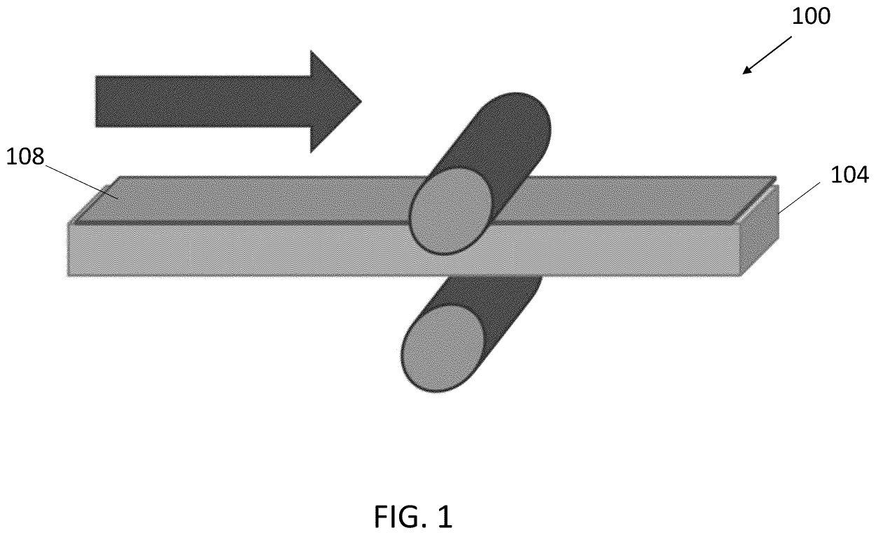

With reference now to the figures, FIG. 1 illustrates an electrically insulated conductor 100 according to an exemplary embodiment. The electrically insulated conductor 100 includes an electrically conductive core 104 (e.g., copper, etc.) and at least one electrically nonconductive or electrically insulating layer 108 (e.g., corona resistant film, etc.).

The at least one electrically nonconductive layer 108 includes adhered end or edge portions that are generally parallel to and/or that longitudinally extend at least partially along the length of the electrically conductive core 104. The at least one electrically nonconductive layer 108 is at least partially or peripherally along or around the perimeter of the electrically conductive core 104.

In exemplary embodiments, the electrically conductive core 104 comprises a copper conductor, and the at least one electrically nonconductive layer 108 comprises a corona resistant film. Advantageously, the corona resistant film may be less costly (e.g., ⅛ less, etc.) than conventional insulation solutions while also providing comparable performance and better formability than the more costly conventional insulation solutions. In alternative exemplary embodiments, the electrically conductive core 104 may comprise other electrical conductors besides copper (e.g., aluminum, stainless steel, copper alloys, other alloys, other metals, electrical conductors with non-rectangular cross-sectional shapes, etc.) and/or the at least one electrically nonconductive layer 108 may comprise other insulators besides corona resistant film.

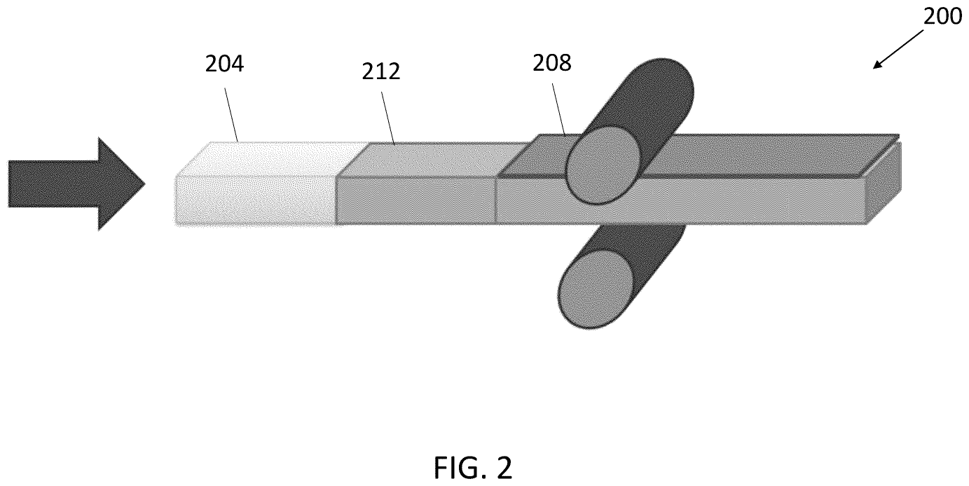

FIG. 2 illustrates an electrically insulated conductor 200 according to another exemplary embodiment. The electrically insulated conductor 200 includes an electrically conductive core 204 (e.g., copper, etc.), at least one electrically nonconductive or electrically insulating layer 208 (e.g., corona resistant film, etc.), and enamel 212.

The enamel 212 is coated or otherwise applied at least partially along the length of the electrically conductive core 204. The at least one electrically nonconductive layer 208 includes adhered end or edge portions that are generally parallel to and/or that longitudinally extend at least partially along the length of the electrically conductive core 204. The at least one electrically nonconductive layer 208 extends at least partially along the length of the electrically conductive core 204 and covers at least a portion of the enamel 212.

In exemplary embodiments, the electrically conductive core 204 comprises a copper conductor, and the at least one electrically nonconductive layer 208 comprises a corona resistant film. In alternative exemplary embodiments, the electrically conductive core 204 may comprise other electrical conductors besides copper (e.g., aluminum, stainless steel, copper alloys, other alloys, other metals, electrical conductors with non-rectangular cross-sectional shapes, etc.) and/or the at least one electrically nonconductive layer 208 may comprise other insulators besides corona resistant film.

As shown by FIGS. 1 and 2, an electrically insulated conductor may include one or more electrically nonconductive layers provided along the electrically conductive core without any enamel coating along the electrically conductive core (FIG. 1) or after an enamel coating having been provided along the electrically conductive core (FIG. 2).

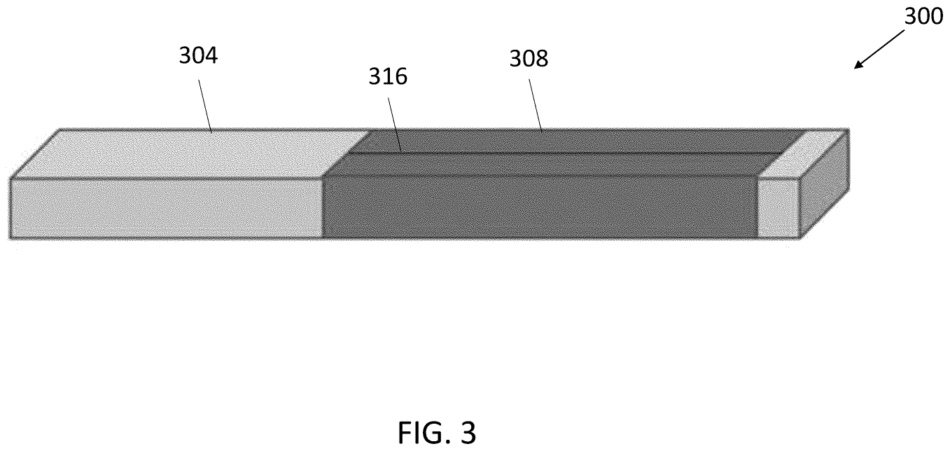

FIG. 3 illustrates an electrically insulated conductor 300 according to another exemplary embodiment. The electrically insulated conductor 300 includes an electrically conductive core 304 (e.g., copper, aluminum, stainless steel, alloys thereof, other metals, electrical conductors with non-rectangular cross-sectional shapes, etc.) and at least one electrically nonconductive or electrically insulating layer 308 (e.g., a corona resistant film, a functionalized dielectric layer designed for through plane thermal conductivity and/or partial discharge resistance, etc.).

In this example, the electrically conductive core 304 has a generally rectangular cross sectional shape. The at least one electrically nonconductive layer 308 is folded generally perpendicularly to the length of the electrically conductive core 304 around the entire generally rectangular perimeter of the electrically conductive core 304.

The at least one electrically nonconductive layer 308 includes adhered end or edge portions that are generally parallel to and/or that longitudinally extend at least partially along the length of the electrically conductive core 304. In this example, the adhered end or edge portions of the at least one electrically nonconductive layer 308 are linear or straight and generally define a longitudinal linear or straight seam 316 therebetween that extends longitudinally at least partially along the length of the electrically conductive core 304.

In other exemplary embodiments, the electrically insulated conductor may include one or more electrically nonconductive layers that have non-linear end or edge portions (e.g., S-shaped, zigzag, interleaving patterns, etc.). For example, the opposite end or edge portions of an electrically nonconductive layer may include complimentary shapes such that one end or edge portion interleaves with the other end or edge portion when the electrically nonconductive layer is folded around the electrically conductive core.

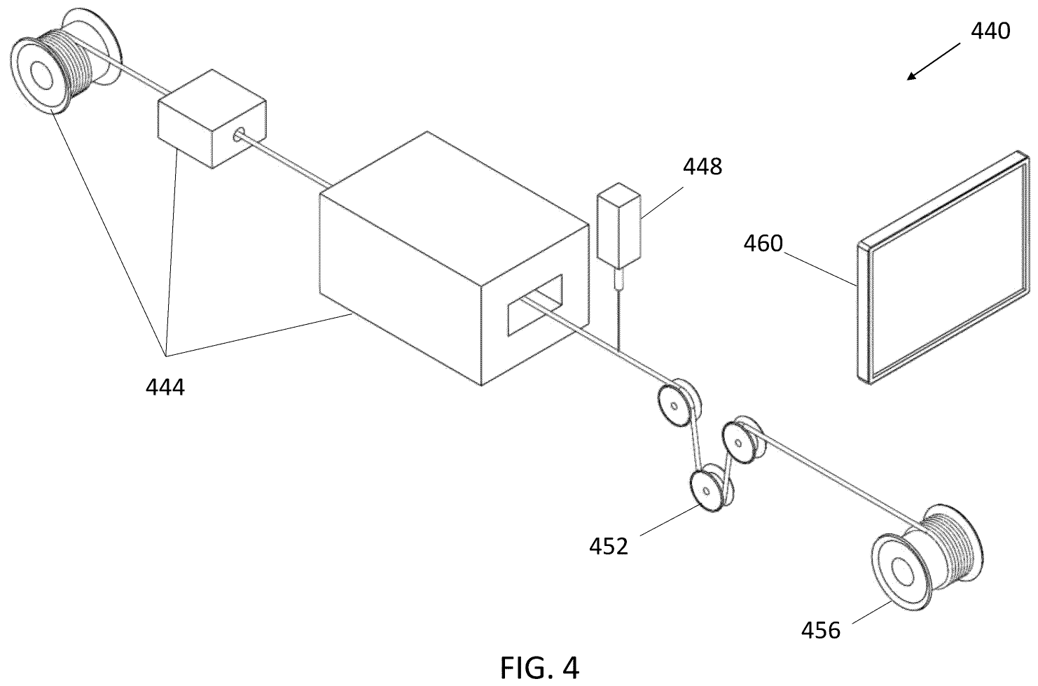

FIG. 4 illustrates an exemplary system 440 that may be used for providing an electrically nonconductive or electrically insulating layer (e.g., a corona resistant film, a functionalized dielectric layer designed for through plane thermal conductivity and/or partial discharge resistance etc.) to an electrically conductive core (e.g., copper, aluminum, stainless steel, copper alloy, other alloys, other metals, etc.). Generally, the system 400 includes a folding system 444, laser outside diameter control 448, tension control 452, spooling or wind up 456, and a process control system 460.

In exemplary embodiments, an electrically insulated conductor comprises an electrically conductive core and one or more electrically nonconductive and/or insulating layers. The one or more electrically nonconductive layers include adhered end portions parallel to and/or longitudinally extending at least partially along the length of the electrically conductive core. The one or more electrically nonconductive layers are at least partially along the perimeter of the electrically conductive core.

In exemplary embodiments, an electrically insulated conductor for a winding driven by a converter device comprises an electrically conductive core and one or more electrically nonconductive and/or insulating layers. The one or more electrically nonconductive layers longitudinally extends at least partially along the length of the electrically conductive core.

The one or more electrically nonconductive layers longitudinally may be non-homogeneous and/or asymmetric at least partially along the perimeter of the electrically conductive core. Or the one or more electrically nonconductive layers longitudinally may be symmetric at least partially along the perimeter of the electrically conductive core. The one or more electrically nonconductive layers longitudinally is configured for targeting one or more predetermined areas of high electrical fields along the electrically conductive core in the winding. At least a portion of the one or more electrically nonconductive layers will be located at or adjacent the one or more predetermined areas of high electrical fields along the electrically conductive core in the winding driven by the converter device (e.g., stator winding in an electric motor or other power electronics device, etc.).

In exemplary embodiments, the one or more electrically nonconductive layers include end or edge portions at least partially adhered along at least one side of the electrically conductive core.

In exemplary embodiments, the one or more electrically nonconductive layers are longitudinally folded at least partially around the perimeter of the electrically conductive core. The one or more electrically nonconductive layers may be fully folded around the perimeter of the electrically conductive core. The one or more electrically nonconductive layers may be fully folded around the perimeter of the electrically conductive core with at least one overlap, such that at least one portion of the one or more electrically nonconductive layers overlaps at least one other portion of the one or more electrically nonconductive layers. The one or more electrically nonconductive layers may be fully folded around the perimeter of the electrically conductive core with multiple overlaps such that multiple portions of the one or more electrically nonconductive layers overlap multiple other portions of the one or more electrically nonconductive layers.

In exemplary embodiments, the one or more electrically nonconductive layers are folded generally perpendicularly to the length of the electrically conductive core at least partially around the perimeter of the electrically conductive core.

In exemplary embodiments, the one or more electrically nonconductive layers are non-homogeneous and/or asymmetric at least partially along the perimeter of the electrically conductive core. In other exemplary embodiments, the one or more electrically nonconductive layers are symmetric at least partially along the perimeter of the electrically conductive core.

In exemplary embodiments, the one or more electrically nonconductive layers are configured to electrically insulate the electrically conductive core for targeting one or more predetermined areas of high electrical fields along the electrically conductive core in a winding driven by a converted device (e.g., a stator winding of an electric motor or power electronics device, etc.). At least a portion of the one or more electrically nonconductive layers will be located at or adjacent the one or more predetermined areas of high electrical fields along the electrically conductive core in the stator winding such as turn to turn areas of the electrically conductive core.

In exemplary embodiments, the one or more electrically nonconductive layers comprise at least one functionalized dielectric layer designed for through plane thermal conductivity and/or partial discharge resistance. For example, an exemplary embodiment may include a thermal substrate as disclosed in U.S. Patent Application Publication US2021/0111097, which is incorporated herein by reference in its entirety. In such exemplary embodiment, the thermal substrate includes a multilayer film that comprises a first outer layer, a core layer, and a second outer layer. The first outer layer includes a first thermoplastic polyimide. The core layer includes a polyimide. The second outer layer includes a second thermoplastic polyimide. A first conductive layer adhered to the first outer layer of the multilayer film. A second conductive layer is adhered to the second outer layer of the multilayer film. The multilayer film has a total thickness in a range of from 5 micrometers (μm) to 150 micrometers (μm). The first outer layer, the core layer, and the second outer layer each includes a thermally conductive filler. The first conductive layer and the second conductive layer each have a thickness in a range of from 250 micrometers (μm) to 3000 micrometers (μm).

In exemplary embodiments, the one or more electrically nonconductive layers comprise a multilayer structure. The multilayer structure may comprise at least one or more dielectric layers including one or more of enamel(s), adhesive promoter, varnish, extruded and/or engineered polymer, a polymer film, and/or a polymer film functionalized with inorganic and/or organic particles such as corona resistant, foamed and others. The multilayer structure may comprise at least one or more dielectric layers including one or more enamel(s) comprising a type(s) of varnish. The type(s) of varnish may include polyimide, polyamide-imide, polyesterimide, and/or combinations thereof, and/or the type(s) of varnish may be functionalized with inorganic and/or organic particles such as corona resistant, foamed and others. The multilayer structure may include one or more semi-conductive layers, e.g., configured to help reduce corona induced breakdown of the insulation, etc.

In exemplary embodiments, the electrically insulated conductor comprises an adhesive for adhesive attachment of the one or more electrically nonconductive layers. The adhesive may be capable of maintaining a relative thermal index of at least about 180 degrees Celsius. The adhesive may be capable of adhesively bonding to electrically-conductive surfaces, metallic surfaces, and polymeric surfaces.

In exemplary embodiments, the electrically insulated conductor includes a polymeric surface (e.g., enamel or other polymeric coating, etc.) along at least a portion the electrically conductive core. The one or more electrically nonconductive layers covers at least a portion of the polymeric surface such that the covered portion of the polymeric surface is between the electrically conductive core and the one or more electrically nonconductive layers. The polymeric surface may include at least one region not covered by the one or more electrically nonconductive layers and that is positioned generally between at least two spaced apart, noncontiguous portions of the one or more electrically nonconductive layers. Or the one or more electrically nonconductive layers may cover an entirety of the polymeric surface. The polymeric surface may be along an entirety of the periphery of the electrically conductive core.

In exemplary embodiments, the one or more electrically nonconductive layers comprise enamel or other polymer coating.

In exemplary embodiments, the one or more electrically nonconductive layers comprise a first nonconductive layer. The electrically insulated conductor includes a second nonconductive layer comprising enamel (or other polymeric coating) longitudinally extending at least partially along the length of the electrically conductive core and at least partially around the perimeter of the electrically conductive core.

In exemplary embodiments, the electrically conductive core has a generally rectangular, round, oval, rhomboid, or rounded rectangular cross-sectional shape or other cross sectional shape with at least one side. The electrically insulated conductor has a generally rectangular round, oval, rhomboid, or rounded rectangular cross-sectional shape or other cross sectional shape with at least one side cooperatively defined by the electrically conductive core and the one or more electrically nonconductive layers. But in other exemplary embodiments, the electrically conductive core and/or the electrically insulated conductor may be configured differently and have a different cross-sectional shape than disclosed in this paragraph.

In exemplary embodiments, the electrically conductive core comprises a magnet wire. The magnet wire may comprise a copper wire, aluminum wire, stainless steel wire, copper alloy wire, other magnet wire, wire made from other metals, wire made from other metal alloy.

In exemplary embodiments, the electrically conductive core comprises a copper, aluminum, or stainless steel wire having a generally rectangular, round, oval, rhomboid, or rounded rectangular cross-sectional shape or other cross sectional shape with at least one side. But in other exemplary embodiments, the electrically conductive core may be configured differently, e.g., comprise a different electrically conductive material and/or have a different cross-sectional shape than disclosed in this paragraph.

In exemplary embodiments, the one or more electrically nonconductive layers are folded at least partially around the perimeter of the electrically conductive core, such that no portion of the one or more electrically nonconductive layers are overlapped and covered by another portion of the one or more electrically nonconductive layers.

In exemplary embodiments, the one or more electrically nonconductive layers are folded around the entire perimeter of the electrically conductive core, such that only opposite first and second longitudinal edge or end portions of the one or more electrically nonconductive layers overlap and no other portion of the one or more electrically nonconductive layers are overlapped by another portion of the one or more electrically nonconductive layers. The first and second longitudinal edge or end portions may be straight, linear, or non-linear (e.g., S-shaped, zigzag, interleaving patterns, etc.). Accordingly, exemplary embodiments are not limited to electrically nonconductive layers having only straight or linear edge or end portions.

In exemplary embodiments, the one or more electrically nonconductive layers are folded around the entire perimeter of the electrically conductive core, such that the one or more electrically nonconductive layers include opposite first and second longitudinal edge or end portions that abut each other without any portion of the one or more electrically nonconductive layers being overlapped and covered by another portion of the one or more electrically nonconductive layers.

In exemplary embodiments, the one or more electrically nonconductive layers are folded around less than the entire perimeter of the electrically conductive core, such that the one or more electrically nonconductive layers include opposite first and second longitudinal edge or end portions that are spaced apart from each other and noncontiguous, the spaced apart first and second longitudinal edge or end portions defining a gap therebetween that extends longitudinally at least partially along the length of the electrically conductive core.

In exemplary embodiments, the one or more electrically nonconductive layers are folded around the entire perimeter of the electrically conductive core, such that the one or more electrically nonconductive layers include opposite first and second longitudinal edge or end portions that abut each other, the abutting first and second longitudinal edge or end portions defining a longitudinal seam therebetween that extends longitudinally at least partially along the length of the electrically conductive core.

In exemplary embodiments, the one or more electrically nonconductive layers may include first and second longitudinal edge or end portions that are straight, linear, or non-linear (e.g., S-shaped, zigzag, interleaving patterns, etc.). Accordingly, exemplary embodiments are not limited to electrically nonconductive layers having only straight or linear edge or end portions.

In exemplary embodiments, the one or more electrically nonconductive layers are folded around the entire perimeter of the electrically conductive core, such that the one or more electrically nonconductive layers include opposite first and second longitudinal edge or end portions that overlap each other, the overlapped first and second longitudinal edge or end portions defining an overlapping seam therebetween that extends at least partially along the length of the electrically conductive core.

In exemplary embodiments, the electrically conductive core includes a plurality of sides defining the perimeter. The one or more electrically nonconductive layers are folded such that the one or more electrically nonconductive layers longitudinally extends at least partially along at least two sides of the plurality of sides of the electrically conductive core.

In exemplary embodiments, the one or more electrically nonconductive layers are folded such that the one or more electrically nonconductive layers longitudinally extends at least partially along each side of the plurality of sides of the electrically conductive core.

In exemplary embodiments, the electrically conductive core includes a plurality of sides defining the perimeter. The one or more electrically nonconductive layers are folded such that the one or more electrically nonconductive layers longitudinally extends along less than all sides of the plurality of sides of the electrically conductive core.

In exemplary embodiments, the electrically conductive core includes a plurality of sides defining the perimeter. The one or more electrically nonconductive layers are disposed along only one side of the plurality of sides of the electrically conductive core.

In exemplary embodiments, the electrically conductive core includes a plurality of sides defining the perimeter. The one or more electrically nonconductive layers are spirally wrapped with polymer film (e.g., with adhesive, etc.). And the electrically insulated conductor includes a second one or more electrically nonconductive layers disposed along only one side or along the plurality of sides of the electrically conductive core.

In exemplary embodiments, the electrically conductive core includes a plurality of sides defining the perimeter. The one or more electrically nonconductive layers are disposed along only one side or along the plurality of sides of the electrically conductive core And the electrically insulated conductor includes a second one or more electrically nonconductive layers spirally wrapped with polymer film (e.g., with adhesive, etc.).

In exemplary embodiments, the one or more electrically nonconductive layers are configured to electrically insulate the electrically conductive core for use in a distributed electrical winding. The one or more electrically nonconductive layers are configured to provide a dielectric barrier for the distributed electrical winding defined by the electrically insulated conductor.

In exemplary embodiments, the electrically insulated conductor is configured to withstand a voltage stress of 1,6 KvPK 20 KHz for at least about 15 to 20 hours.

Exemplary embodiments include windings driven by a converter devices (e.g., a stator winding for an electric motor or other power electronics device, etc.) that include an electrically insulated conductor as disclosed herein. The one or more electrically nonconductive layers of the electrically insulated conductor is located at or adjacent one or more predetermined areas of high electrical fields along the electrically conductive core in the winding.

Also disclosed are exemplary methods of manufacturing electrically insulated conductors for windings driven by converter devices (e.g., stator windings of electric motors or power electronics devices, etc.). In exemplary embodiments, the method comprises adhering end or edge portions of one or more electrically nonconductive layers parallel to and/or longitudinally at least partially along the length of the electrically conductive core. The one or more electrically nonconductive layers are at least partially along the perimeter of the electrically conductive core and configured for targeting one or more predetermined areas of high electrical fields along the electrically conductive core in a winding driven by a converter device.

In exemplary embodiments, the method includes folding the one or more electrically nonconductive layers at least partially around the perimeter of the electrically conductive core, such that the one or more electrically nonconductive layers are non-homogeneous and/or asymmetrical at least partially along the perimeter of the electrically conductive core; or such that the one or more electrically nonconductive layers are symmetric at least partially along the perimeter of the electrically conductive core. At least a portion of the one or more electrically nonconductive layers will be located at or adjacent the one or more predetermined areas of high electrical fields along the electrically conductive core in the winding driven by the converter device.

In exemplary embodiments, the method includes positioning the electrically insulated conductor within the winding such that at least a portion of the one or more electrically nonconductive layers will be located at or adjacent the one or more predetermined areas of high electrical fields along the electrically conductive core in the winding driven by the converter device.

In exemplary embodiments, the method includes selectively applying the one or more electrically nonconductive layers at least partially along the length of the electrically conductive core, to thereby enable an environmentally sustainable reduction in use of electrically nonconductive material.

In exemplary embodiments, the method includes selectively applying pieces of the one or more electrically nonconductive layers at spaced apart indexed locations along the length of the electrically conductive core.

In exemplary embodiments, the method includes manufacturing an electrically insulated conductor as disclosed herein.

In exemplary embodiments, a system is configured for performing a method of manufacturing an electrically insulated conductor as disclosed herein.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific numerical dimensions and values, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter may be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected, or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section could be termed a second element, component, region, layer, or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrically insulated conductor comprising:
an electrically conductive core having a length and a perimeter; and
one or more electrically nonconductive layers including end portions parallel to and/or longitudinally extending at least partially along the length of the electrically conductive core, the one or more electrically nonconductive layers at least partially along the perimeter of the electrically conductive core.

2. The electrically insulated conductor of claim 1, wherein the one or more electrically nonconductive layers comprise a thin corona resistant film including adhered end portions parallel to and longitudinally extending at least partially along the length of the electrically conductive core, the thin corona resistant film at least partially along the perimeter of the electrically conductive core.

3. The electrically insulated conductor of claim 1, wherein the one or more electrically nonconductive layers are configured to electrically insulate the electrically conductive core for targeting one or more predetermined areas of high electrical fields along the electrically conductive core in a winding driven by a converter device, whereby at least a portion of the one or more electrically nonconductive layers will be located at or adjacent the one or more predetermined areas of high electrical fields along the electrically conductive core in the winding.

4. The electrically insulated conductor of claim 1, wherein:
the one or more electrically nonconductive layers are non-homogeneous and/or asymmetric at least partially along the perimeter of the electrically conductive core; or
the one or more electrically nonconductive layers are symmetric at least partially along the perimeter of the electrically conductive core.

5. The electrically insulated conductor of claim 1 configured for a winding driven by an inverter device, wherein:
the one or more electrically nonconductive layers are configured for targeting one or more predetermined areas of high electrical fields along the electrically conductive core in the winding driven by the inverter device, whereby at least a portion of the one or more electrically nonconductive layers will be located at or adjacent the one or more predetermined areas of high electrical fields along the electrically conductive core in the winding driven by the inverter device; and
the one or more electrically nonconductive layers longitudinally extend at least partially along the length of the electrically conductive core such that:
the one or more electrically nonconductive layers are non-homogeneous and/or asymmetrical at least partially along the perimeter of the electrically conductive core; or
the one or more electrically nonconductive layers are symmetric at least partially along the perimeter of the electrically conductive core.

6. The electrically insulated conductor of claim 1, wherein:
the end portions of the one or more electrically nonconductive layers include are at least partially adhered along at least one side of the electrically conductive core; and/or
the one or more electrically nonconductive layers are longitudinally folded at least partially around the perimeter of the electrically conductive core.

7. The electrically insulated conductor of claim 6, wherein the one or more electrically nonconductive layers are fully folded around the perimeter of the electrically conductive core.

8. The electrically insulated conductor of claim 7, wherein the one or more electrically nonconductive layers are fully folded around the perimeter of the electrically conductive core with at least one overlap, such that at least one portion of the one or more electrically nonconductive layers overlaps at least one other portion of the one or more

9. The electrically insulated conductor of claim 8, wherein the one or more electrically nonconductive layers are fully folded around the perimeter of the electrically conductive core with multiple overlaps such that multiple portions of the one or more electrically nonconductive layers overlap multiple other portions of the one or more electrically nonconductive layers.

10. The electrically insulated conductor of claim 1, wherein the one or more electrically nonconductive layers are folded generally perpendicularly to the length of the electrically conductive core at least partially around the perimeter of the electrically conductive core.

11. The electrically insulated conductor of claim 1, wherein the one or more electrically nonconductive layers comprise at least one functionalized dielectric layer designed for through plane thermal conductivity and/or partial discharge resistance.

12. The electrically insulated conductor of claim 1, wherein the one or more electrically nonconductive layers comprise a multilayer structure including at least one or more dielectric layers, and wherein:
the at least one or more dielectric layers include one or more of enamel(s), adhesive promoter, varnish, extruded polymer, engineered polymer, a polymer film, and/or a polymer film functionalized with inorganic and/or organic particles; and/or
the at least one or more dielectric layers include one or more enamel(s) comprising:
a type(s) of varnish including polyimide, polyamide-imide, polyesterimide, and/or combinations thereof;
a type(s) of varnish functionalized with inorganic and/or organic particles.

13. The electrically insulated conductor of claim 1, wherein the one or more electrically nonconductive layers comprise a multilayer structure including one or more semi-conductive layers configured to help reduce corona induced breakdown of the one or more

14. The electrically insulated conductor of claim 1, wherein:
the electrically insulated conductor includes a polymeric surface along at least a portion the electrically conductive core and/or along an entirety of the periphery of the electrically conductive core; and
the one or more electrically nonconductive layers cover at least a portion of the polymeric surface such that the covered portion of the polymeric surface is between the electrically conductive core and the one or more electrically nonconductive layers.

15. The electrically insulated conductor of claim 14, wherein:
the polymeric surface includes at least one region not covered by the one or more electrically nonconductive layers and that is positioned generally between at least two spaced apart, noncontiguous portions of the one or more electrically nonconductive layers; or
the one or more electrically nonconductive layers covers an entirety of the polymeric surface.

16. The electrically insulated conductor of claim 1, wherein:
the one or more electrically nonconductive layers comprise enamel and/or a thin corona resistant film; and/or
the electrically conductive core comprises a magnet wire.

17. The electrically insulated conductor of claim 1, wherein:
the one or more electrically nonconductive layers comprise a first nonconductive layer; and
the electrically insulated conductor includes a second nonconductive layer comprising enamel longitudinally extending at least partially along the length of the electrically conductive core and at least partially around the perimeter of the electrically conductive core.

18. The electrically insulated conductor of claim 1, wherein the one or more electrically nonconductive layers are folded at least partially around the perimeter of the electrically conductive core, such that no portion of the one or more electrically nonconductive layers are overlapped and covered by another portion of the one or more electrically nonconductive layers.

19. The electrically insulated conductor of claim 1, wherein the one or more electrically nonconductive layers are folded around the entire perimeter of the electrically conductive core, such that only opposite first and second longitudinal end portions of the one or more electrically nonconductive layers overlap and no other portion of the one or more electrically nonconductive layers are overlapped by another portion of the one or more electrically nonconductive layers.

20. The electrically insulated conductor of claim 1, wherein the one or more electrically nonconductive layers are folded around the entire perimeter of the electrically conductive core, such that the one or more electrically nonconductive layers include opposite first and second longitudinal end portions that abut each other without any portion of the one or more electrically nonconductive layers being overlapped and covered by another portion of the one or more electrically nonconductive layers and/or the abutting first and second longitudinal end portions defining a longitudinal seam therebetween that extends longitudinally at least partially along the length of the electrically conductive core.

21. The electrically insulated conductor of claim 1, wherein the one or more electrically nonconductive layers are folded around the entire perimeter of the electrically conductive core, such that the one or more electrically nonconductive layers include opposite first and second longitudinal end portions that overlap each other, the overlapped first and second longitudinal end portions defining an overlapping seam therebetween that extends at least partially along the length of the electrically conductive core.

22. The electrically insulated conductor of claim 1, wherein the one or more electrically nonconductive layers are folded around less than the entire perimeter of the electrically conductive core, such that the one or more electrically nonconductive layers include opposite first and second longitudinal end portions that are spaced apart from each other and noncontiguous, the spaced apart first and second longitudinal end portions defining a gap therebetween that extends longitudinally at least partially along the length of the electrically conductive core.

23. The electrically insulated conductor of claim 1, wherein:
the electrically conductive core includes a plurality of sides defining the perimeter; and
the one or more electrically nonconductive layers are folded such that:
the one or more electrically nonconductive layers longitudinally extend at least partially along at least two sides of the plurality of sides of the electrically conductive core; or
the one or more electrically nonconductive layers longitudinally extend at least partially along each side of the plurality of sides of the electrically conductive core; or
the one or more electrically nonconductive layers longitudinally extend along less than all sides of the plurality of sides of the electrically conductive core; or
the one or more electrically nonconductive layers are disposed along only one side of the plurality of sides of the electrically conductive core.

24. The electrically insulated conductor of claim 1, wherein the electrically conductive core includes a plurality of sides defining the perimeter, and wherein:
the one or more electrically nonconductive layers are spirally wrapped with polymer film, and the electrically insulated conductor includes a second one or more electrically nonconductive layers disposed along only one side or along the plurality of sides of the electrically conductive core; or
the one or more electrically nonconductive layers are disposed along only one side or along the plurality of sides of the electrically conductive core, and the electrically insulated conductor includes a second one or more electrically nonconductive layers spirally wrapped with polymer film.

25. The electrically insulated conductor of claim 1, wherein the one or more electrically nonconductive layers are configured to electrically insulate the electrically conductive core for use in a distributed electrical winding, whereby the one or more electrically nonconductive layers are configured to provide a dielectric barrier for the distributed electrical winding defined by the electrically insulated conductor.

26. A winding driven by a converter device, the winding comprising the electrically insulated conductor of claim 1, wherein the one or more electrically nonconductive layers are located at or adjacent one or more predetermined areas of high electrical fields along the electrically conductive core in the winding.

27. A stator winding for an electric motor, the stator winding comprising the electrically insulated conductor of claim 1, wherein the one or more electrically nonconductive layers are located at or adjacent one or more predetermined areas of high electrical fields along the electrically conductive core in the stator winding.

28. A method of manufacturing an electrically insulated conductor for a winding driven by a converter device, the method comprising adhering end portions of one or more electrically nonconductive layers parallel to and/or longitudinally at least partially along a length of an electrically conductive core, such that the one or more electrically nonconductive layers are at least partially along a perimeter of the electrically conductive core and configured for targeting one or more predetermined areas of high electrical fields along the electrically conductive core in a winding driven by a converter device.

29. The method of claim 28, wherein the method includes folding the one or more electrically nonconductive layers at least partially around the perimeter of the electrically conductive core, such that:
the one or more electrically nonconductive layers are non-homogeneous and/or asymmetrical at least partially along the perimeter of the electrically conductive core; or
the one or more electrically nonconductive layers are symmetric at least partially along the perimeter of the electrically conductive core;
whereby at least a portion of the one or more electrically nonconductive layers will be located at or adjacent the one or more predetermined areas of high electrical fields along the electrically conductive core in the winding driven by the converter device.

30. The method of claim 28, wherein the method includes positioning the electrically insulated conductor within the winding such that at least a portion of the one or more electrically nonconductive layers will be located at or adjacent the one or more predetermined areas of high electrical fields along the electrically conductive core in the winding driven by the converter device.

31. The method of claim 28, wherein the method includes selectively applying the one or more electrically nonconductive layers at least partially along the length of the electrically conductive core.

32. The method of claim 28, wherein the method includes selectively applying pieces of the one or more electrically nonconductive layers at spaced apart indexed locations along the length of the electrically conductive core.
